(19) United States
(12) Patent Application Publication
(10) Pub. No.: US 2013/0216664 A1
(43) Pub. Date: Aug. 22, 2013

(54) CONTROLLING HEAT INDUCED FOAM GENERATION OF FOODSTUFF

(71) Applicants: Teresa Elliot, Paola, KS (US); John P. Neddersen, Gardner, KS (US)

(72) Inventors: Teresa Elliot, Paola, KS (US); John P. Neddersen, Gardner, KS (US)

(73) Assignee: DANISCO A/S, DK-1001 COPENHAGEN K (DK)

(21) Appl. No.: 13/500,346

(22) PCT Filed: Oct. 4, 2010
(86) PCT No.: PCT/IB2010/054466

§ 371 Date: Jan. 9, 2013

Related U.S. Application Data
(60) Provisional application No. 61/325,953, filed on Apr. 20, 2010.

(30) Foreign Application Priority Data
Oct. 5, 2009 (GB) 0917304.8

(51) Int. Cl. A23L 3/3508

(52) U.S. Cl. CPC A23L 3/3508
USPC 426/243; 426/654; 426/329

(57) ABSTRACT

The present invention relates to the use of a composition to control the degree of heat induced foam generation in a foodstuff system when said foodstuff system is heated, wherein the composition comprises polyglycerol polyricinoleic acid.

### CROSS-REFERENCE TO RELATED APPLICATIONS

This application is a national phase U.S. application of PCT Application No. PCT/IB2010/054466 filed Oct. 4, 2010, which claims priority to U.S. Provisional Application No. 61/325,953 filed Apr. 20, 2010, which claims priority to European Patent Application No. 0917304.8 filed Oct. 5, 2009.

### TECHNICAL FIELD

The present invention relates to a use. In particular, the present invention relates to the use of a composition to control the degree of heat induced foam generation in a foodstuff system when said foodstuff system is heated.

### BACKGROUND OF THE INVENTION

Present day consumers expect normal and convenience foodstuffs to be capable of being heated quickly for consumption. There are various methods of heating foodstuffs quickly. Such methods can include suspending the foodstuff in water which is of sufficient temperature to satisfactorily heat and/or cook the foodstuff, e.g. boiling water. Other methods include subjecting the foodstuff, either alone or suspended in a liquid, to microwaves, i.e. by placing the foodstuff in a microwave oven.

However, such methods of heating foodstuffs can create a number of drawbacks. For example, where the foodstuff is heated rapidly, liquid used to heat the foodstuff or liquid present in the foodstuff itself (for example where the foodstuff is a soup) will begin to boil. This boiling leads to the increase in the volume of the total substance being heated due to the liberation of gas from the liquids, i.e. results in the formation of bubbles and/or foam.

This increase in the total volume of the substance being heated is troublesome. If the heating is being conducted on, for example, a stove, the container in which the foodstuff is being heated in will need to be large enough so as to prevent the bubbles and/or foam from overflowing. However, use of oversize containers can lead to inefficient concentration of heat and therefore potentially increase the time and energy required in order to heat the foodstuff. Further, loss of liquid due to the overflow of bubbles and/or liquid can lead to the volume of the liquid in the container being reduced and the container effectively “boiling dry”. This is clearly undesirable as it can have a detrimental effect on the foodstuff being cooked, as well as present a potential safety issue.

A similar problem is encountered when heating the foodstuff in a microwave. As the liquid (be it the foodstuff itself or the liquid in which the foodstuff is being heated in) begins to increase in temperature bubbles and/or foam being to rise within the container and overflow unless an oversize container is used. Some of the issues with oversize containers have already been mentioned above.

A further problem of the use of such oversize containers is the consumer impression of the cooked foodstuff. It is unsatisfactory from the perspective of the consumer to find that the amount of foodstuff purchased, say in a plastic container, does not completely fill the container.

A further problem associated with the generation of excessive foam is that the foam produced by the heating of the foodstuff can become burnt. This burning of the foam can result in “caking” on the surface of the cooked foodstuff, which is not pleasant for the consumer from a visual or taste perspective.

Also, where the foam spills over from the container in which the foodstuff is being heated, it can be burnt onto the surface of the cooking apparatus used to heat the foodstuff. For example, where a stove is being used to heat the foodstuff, foam which has overflowed onto the surface of the stove will be burnt onto the surface of the stove. This is highly undesirable, as it results in an unsightly residue being left on the stove which is often difficult to remove. A similar effect can also be seen when, for example, the foodstuff is cooked in a microwave and foam is projected onto the inner surfaces of the microwave. The subsequent burning of this foam results in a residue which is difficult to remove and may leave unpleasant odours in the microwave.

US 2006/0121168 suggests the use of a three component composition comprising salt, instant starch and at least one surfactant as an “anti boil-over” composition.

In view of the above, it would be desirable to produce a composition which could be used to control the degree of boil-over in a foodstuff when said foodstuff is heated.

### BRIEF SUMMARY OF THE INVENTION

The present invention provides the use of a composition to control the degree of heat induced foam generation in a foodstuff system when said foodstuff system is heated, wherein the composition comprises polyglycerol polyricinoleic acid.

It has been surprisingly found that compositions comprising polyglycerol polyricinoleic acid are particularly effective at controlling the heat induced foam generation in a system comprising a liquid foodstuff, a solid foodstuff immersed in a liquid, and/or a mixture of a liquid foodstuff with an additional liquid.

It has also surprisingly been found that a one component composition can be used to successfully control heat induced foam generation in a system comprising a liquid foodstuff, a solid foodstuff immersed in a liquid, and/or a mixture of a liquid foodstuff with an additional liquid.

An advantage of the use of the present invention is that the amount of heat induced foam generation can be controlled without significantly affecting the taste profile of the foodstuff.

Therefore, in one aspect of the present invention there is provided the use of a composition to control the degree of heat induced foam generation in a foodstuff system when said foodstuff system is heated, wherein the composition comprises polyglycerol polyricinoleic acid.

In a second aspect of the present invention, there is provided an anti foaming composition wherein the composition comprises polyglycerol polyricinoleic acid.

For ease of reference these and further aspects of the present invention are now discussed under appropriate section headings. However, the teachings under each section are not necessarily limited to each particular section.

### DETAILED DESCRIPTION

In one aspect of the present invention, there is provided the use of a composition to control the degree of heat induced foam generation in a foodstuff system when said foodstuff system is heated, wherein the composition comprises polyglycerol polyricinoleic acid.

### Heat Induced Foam Generation

According to the present invention, there is provided the use of a composition to control the degree of heat induced foam generation in a foodstuff system when said foodstuff system is heated. Heat induced foam generation, as herein defined, refers to the volume of bubbles and/or foam generated from a foodstuff system, when that system is heated. The heating of the foodstuff system need not be such that the foodstuff system boils. Thus, the present invention encompasses the control of heat induced foam generation where the foodstuff system is heated to temperatures other than 100° C.

It will be understood that the term “control” includes reducing, preventing, inhibiting, suppressing and terminating the amount of heat induced foam generation produced by the foodstuff system.

It will also be understood that the term “foam” refers to the manifestation of gas liberated from the foodstuff system. The term “foam” therefore also includes bubbles or other descriptions of gas liberation, such as blisters.

FIG. 1 shows an example of a foodstuff system which has undergone heating.

Samples 1 and 2 contain milk. Sample 1 contained no additional composition. Sample 2 contained an additional composition which controlled the degree of heat induced foam generation. FIG. 1a shows each sample before heating. FIG. 1b shows each sample after heating.

As can be seen in FIG. 1b, Sample 1, which contained no additional composition, foamed considerably on heating. The structure of the foam is clearly visible in Sample 1 of FIG. 1b. By contrast, Sample 2, which contained an additional composition which controlled the degree of heat induced foam generation, did not produce foam.

In one embodiment, there is provided the use of a composition to reduce, prevent, inhibit or terminate the degree of heat induced foam generation in a foodstuff system when said foodstuff system is heated, wherein the composition comprises polyglycerol polyricinoleic acid.

In one embodiment, there is provided the use of a composition to reduce the degree of heat induced foam generation in a foodstuff system when said foodstuff system is heated, wherein the composition comprises polyglycerol polyricinoleic acid.

### Foodstuff System

According to the present invention, “foodstuff system” refers to any system comprising either a foodstuff on its own, and/or a foodstuff when combined, coated, and/or immersed in a liquid.

A “foodstuff” is any substance which is suitable for consumption by humans or animals and is intended for that purpose. The foodstuff may be solid or liquid. In some cases, the foodstuff may transform during cooking from a solid to a liquid. Furthermore, foodstuffs comprising a combination of liquid and solid components are also encompassed by the present invention.

Thus, reference to the term “foodstuff system” herein refers to a solid foodstuff alone, a solid foodstuff combined, coated, and/or immersed in a liquid, a liquid foodstuff alone, a liquid foodstuff mixed with an additional liquid and a foodstuff which comprises both solid and liquid components.

Examples of foodstuffs in which the use of the present invention may be employed include, but are not limited to, rice, noodles, pasta, such as macaroni, casseroles, stews, dressings, gravy, beverages, ready to eat meals, cheese sauces, pasta sauces, soups, marinades, marinaded food products, vegetables, beans, pulses, lentils, desserts, oatmeal based foodstuffs, toppings, such as custard, cream and the like, and any of the above when in a dehydrated, powdered or condensed state.

In one embodiment, the foodstuff is selected from the group consisting of rice, noodles, pasta, casseroles, stews, dressings, gravy, beverages, ready to eat meals, pasta sauces, soups, marinades, marinaded food products, vegetables, beans, pulses, lentils, desserts, toppings, such as custard and the like, and any of the above when in a dehydrated, powdered or condensed state.

In one embodiment, the foodstuff is selected from the group consisting of rice, noodles, pasta, casseroles, stews, dressings, gravy, beverages, ready to eat meals, pasta sauces, and soups.

In one embodiment, the foodstuff is selected from the group consisting of rice, noodles, and pasta. In one preferred embodiment, the foodstuff is pasta.

In one embodiment, the foodstuff system is selected from a combination of rice, noodles, and pasta with a liquid.

Where the foodstuff is inherently a solid, e.g. pasta, then it is typically immersed in an amount of water sufficient to completely cover the foodstuff to be cooked. However, less liquid may be utilized as necessary to satisfactorily heat and/or cook the foodstuff.

Thus, in one embodiment, the foodstuff system is selected from a combination of one or more foodstuffs, with a liquid. In one embodiment, the foodstuff system is selected from a combination of one or more of rice, noodles, and pasta, with a liquid.

In one embodiment, where the foodstuff is a solid, the foodstuff is combined, coated, and/or immersed in from 10 ml to 500 ml of liquid. In one embodiment, where the foodstuff is a solid, the foodstuff is combined, coated, and/or immersed in from 100 ml to 450 ml of liquid. In one embodiment, where the foodstuff is a solid, the foodstuff is combined, coated, and/or immersed in from 150 ml to 400 ml of liquid. In one embodiment, where the foodstuff is a solid, the foodstuff is combined, coated, and/or immersed in from 200 ml to 350 ml of liquid. In one embodiment, where the foodstuff is a solid, the foodstuff is combined, coated, and/or immersed in from 250 ml to 350 ml of liquid. In one embodiment, where the foodstuff is a solid, the foodstuff is combined, coated, and/or immersed in about 10 ml of liquid. In one embodiment, where the foodstuff is a solid, the foodstuff is combined, coated, and/or immersed in about 25 ml of liquid. In one embodiment, where the foodstuff is a solid, the foodstuff is combined, coated, and/or immersed in about 35 ml of liquid. In one embodiment, where the foodstuff is a solid, the foodstuff is combined, coated, and/or immersed in about 50 ml of liquid. In one embodiment, where the foodstuff is a solid, the foodstuff is combined, coated, and/or immersed in about 100 ml of liquid. In one embodiment, where the foodstuff is a solid, the foodstuff is combined, coated, and/or immersed in about 150 ml of liquid. In one embodiment, where the foodstuff is a solid, the foodstuff is combined, coated, and/or immersed in about 200 ml of liquid. In one embodiment, where the foodstuff is a solid, the foodstuff is combined, coated, and/or immersed in about 250 ml of liquid. In one embodiment, where the foodstuff is a solid, the foodstuff is combined, coated, and/or immersed in about 300 ml of liquid.

In one embodiment, the liquid in which the foodstuff is combined, coated, and/or immersed in is any suitable liquid for cooking and/or heating a foodstuff in. In one embodiment, the liquid in which the foodstuff is combined, coated, and/or immersed in is water. In one embodiment, the liquid in which the foodstuff is combined, coated, and/or immersed in is water and/or milk.

Where the foodstuff is inherently a liquid, e.g. soup, then it may be heated either on its own or alternatively with an additional liquid. Where an additional liquid is present with the liquid foodstuff, the additional liquid may be present in an amount of from about 10 ml to 10000 ml. In one embodiment, the additional liquid may be present in an amount of from about 10 ml to 1000 ml. In one embodiment, the additional liquid may be present in an amount of from about 10 ml to 500 ml. In one embodiment, the additional liquid may be present in an amount of from about 20 ml to 500 ml. In one embodiment, the additional liquid may be present in an amount of from about 30 ml to 500 ml. In one embodiment, the additional liquid may be present in an amount of from about 40 ml to 500 ml. In one embodiment, the additional liquid may be present in an amount of from about 50 ml to 500 ml. In one embodiment, the additional liquid may be present in an amount of from about 60 ml to 500 ml. In one embodiment, the additional liquid may be present in an amount of from about 75 ml to 500 ml. In one embodiment, the additional liquid may be present in an amount of from about 100 ml to 450 ml. In one embodiment, the additional liquid may be present in an amount of from about 150 ml to 400 ml. In one embodiment, the additional liquid may be present in an amount of from about 200 ml to 350 ml. In one embodiment, the additional liquid may be present in an amount of from about 250 ml to 300 ml. In one embodiment, the additional liquid may be present in an amount of about 10 ml. In one embodiment, the additional liquid may be present in an amount of about 25 ml. In one embodiment, the additional liquid may be present in an amount of about 50 ml. In one embodiment, the additional liquid may be present in an amount of about 75 ml. In one embodiment, the additional liquid may be present in an amount of about 100 ml. In one embodiment, the additional liquid may be present in an amount of about 125 ml. In one embodiment, the additional liquid may be present in an amount of about 150 ml. In one embodiment, the additional liquid is water.

In one embodiment, the additional liquid is any suitable liquid for heating and/or cooking a foodstuff in. In one embodiment, the additional liquid is water and/or milk.

In one embodiment, the use of the present invention is employed in bulk food preparation systems. Thus, the volume of the foodstuff system prior to heating may be from 10 L to 50000 L, although larger volumes may be used. In one embodiment, the volume of the foodstuff is from about 10 L to about 50000 L. In one embodiment, the volume of the foodstuff is from about 100 L to about 15000 L. In one embodiment, the volume of the foodstuff is from about 1000 L to about 15000 L. In one embodiment, the volume of the foodstuff is from about 5000 L to about 15000 L. In one embodiment, the volume of the foodstuff is from about 5000 L to about 10000 L.

### Polyglycerol Polyricinoleic Acid

According to the first aspect of the present invention, the use employs a composition comprising polyglycerol polyricinoleic acid. Thus, in this regard, the use employs a composition wherein a polyglycerol has been reacted with a polymerised fatty acid to form a polyglycerol ester of a polymerised fatty acid.

### Polyglycerols

Polyglycerols are substances consisting of oligomer ethers of glycerol. Polyglycerols are usually prepared from an alkaline polymerisation of glycerol at elevated temperatures.

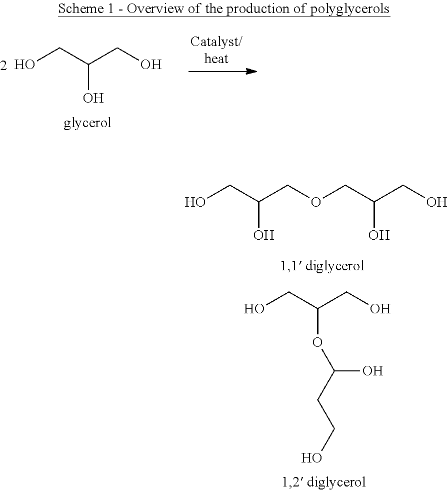 [SMILES: OCC(O)CO ; OCC(O)COCC(O)CO ; OCCC(O)OC(CO)CO]

The processes for making polyglycerols are well known to the person skilled in the art and can be found, for example, in “Emulsifiers in Food Technology”, Blackwell Publishing, edited by RJ Whithurst, page 110 to 130.

It will be understood that the degree of polymerisation can vary. In one embodiment, the polyglycerol used to form the polyglycerol ester of a polymerised fatty acid is selected from diglycerol, triglycerol, tetraglycerol, pentaglycerol, hexaglycerol, heptaglycerol, octaglycerol, nonaglycerol and decaglycerol and mixtures thereof.

In one embodiment, the polyglycerol is considered to be a diglycerol. In one embodiment, the polyglycerol is considered to be a triglycerol. In one embodiment, the polyglycerol is considered to be a tetraglycerol. In one embodiment, the polyglycerol is considered to be a pentaglycerol. In one embodiment, the polyglycerol is considered to be a hexaglycerol. In one embodiment, the polyglycerol is considered to be a heptaglycerol. In one embodiment, the polyglycerol is considered to be an octaglycerol. In one embodiment, the polyglycerol is considered to be a nonaglycerol. In one embodiment, the polyglycerol is considered to be a decaglycerol.

In one embodiment, the polyglycerol moiety shall be composed of not less than 75% of di-, tri- and tetraglycerols and shall contain not more than 10% of polyglycerols equal to or higher than heptaglycerol.

Polyglycerols may be linear, branched or cyclic in structure. Generally, all three types of polyglycerol structure may be present in the composition of the present invention. In one embodiment, the polyglycerol is linear. In one embodiment, the polyglycerol is branched. In one embodiment, the polyglycerol is cyclic.

### Fatty Acids

Fatty acids are well known in the art. They typically comprise an “acid moiety” and a “fatty chain”. The properties of the fatty acid can vary depending on the length of the fatty chain, its degree of saturation, and the presence of any substituents on the fatty chain. Examples of fatty acids are palmitic acid, stearic acid, oleic acid, and ricinoleic acid.

The fatty acid used according to the present invention is ricinoleic acid.

Ricinoleic acid is a chiral molecule. Two steric representations of ricinoleic acid are given below:

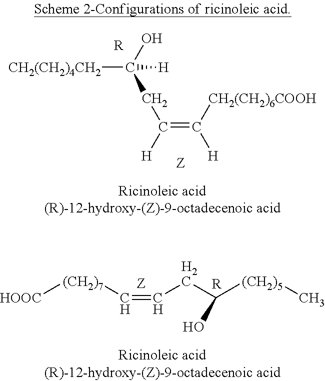

The ricinoleic acid used in the present invention may be prepared by any suitable means known to the person skilled in the art. Typically, fatty acids are produced from a parent oil via hydrolyzation and distillation.

### Polymerized Fatty Acids

The polymerized fatty acid may be prepared by any suitable means for condensing or polymerizing fatty acids. It will be understood that the fatty acid used in the present invention comprises an hydroxyl group. Said hydroxyl groups are present in order to ensure that the polymerization of the fatty acid is not terminated. However, it will be understood by the skilled person that the fatty acid may comprise one or more other groups in addition to, or in place of, the hydroxyl group, which can act to facilitate polymerization of the fatty acid.

Typically, the polymerisation can be carried out by self-condensation of the fatty acid. This can be carried out at about 200 to 210° C., with or without a catalyst, under reduced pressure to remove water liberated from the condensation.

Acceptable catalysts are those known in the art and include acids such as phosphoric acid, bases such as sodium hydroxide, and lipase enzymes. US 2008/0233059 provides at least one method for the production of polymerised fatty acids, in particular, polyricinoleic acid.

The degree of polymerisation of the fatty acids can vary. However, it will be understood by the skilled person that the products of polymerization reactions are typically mixtures of polymers with varying degrees of polymerization. Thus, characterisation of the polymerization product is typically carried out by measuring physical characteristics of the product as a whole.

In one embodiment, the average degree of polymerization is above one fatty acid residue per molecule.

In one embodiment, the polymerized fatty acid comprises an average of two fatty acid residues per molecule. In one embodiment, the polymerized fatty acid comprises an average of three fatty acid residues per molecule. In one embodiment, the polymerized fatty acid comprises an average of four fatty acid residues per molecule. In one embodiment, the polymerized fatty acid comprises an average of five fatty acid residues per molecule. In one embodiment, the polymerized fatty acid comprises an average of six fatty acid residues per molecule. In one embodiment, the polymerized fatty acid comprises an average of seven fatty acid residues per molecule.

In order to produce the polyglycerol polyricinoleic acid, the polyglycerol and polymerised fatty acid can be combined in one of a number of ways. For example, the polyglycerol polyricinoleic acid may be produced by direct esterification of the polyglycerol and the polymerised fatty acid. A further method of producing polyglycerol polyricinoleic acid is described in US 2008/0233059.

In one embodiment, the polyglycerol polyricinoleic acid may be produced by direct esterification of the polyglycerol and the polymerized fatty acid.

As will be appreciated, there are a number of ways in which to produce the polyglycerol polyricinoleic acid. Therefore, it may be that the precise method of production is not critical.

As mentioned above, due to the complexity of the products produced via a process including a polymerization step, said products are often characterised by physical characteristics of the produced polyglycerol polyricinoleic acid.

In one embodiment of the present invention, the polyglycerol polyricinoleic acid has at least one of the following characteristics:

i) an acid value of less than or equal to 2.0 mg KOH;

ii) an alkaline value of about 2.5 to about 4.0 m/100 g; iii) a saponification value of about 175.0 to about 185.0 mgKOH;

iv) an hydroxyl value of about 80.0 to about 100.0 mgKOH;

v) a peroxide value of less than or equal to 3.0 me/kg;

vi) an iodine value of about 72 to about 100 gl₂; and

vii) a refractive index of about 1,4630 to about 1,4665.

### i) Acid Value

In one embodiment, the polyglycerol polyricinoleic acid has an acid value of less than or equal to 2.0 mg KOH. In one embodiment, the polyglycerol polyricinoleic acid has an acid value of less than 1.8 mg KOH. In one embodiment, the polyglycerol polyricinoleic acid has an acid value of less than 1.7 mg KOH. In one embodiment, the polyglycerol polyricinoleic acid has an acid value of less than 1.6 mg KOH. In one embodiment, the polyglycerol polyricinoleic acid has an acid value of less than 1.5 mg KOH. In one embodiment, the polyglycerol polyricinoleic acid has an acid value of less than 1.4 mg KOH. In one embodiment, the polyglycerol polyricinoleic acid has an acid value of less than 1.3 mg KOH. In one embodiment, the polyglycerol polyricinoleic acid has an acid value of less than 1.2 mg KOH. In one embodiment, the polyglycerol polyricinoleic acid has an acid value of less than 1.1 mg KOH. In one embodiment, the polyglycerol polyricinoleic acid has an acid value of about 1.0 mg KOH.

In one embodiment, the polyglycerol polyricinoleic acid has an acid value of from about 0.5 to 1.5 mg KOH. In one embodiment, the polyglycerol polyricinoleic acid has an acid value of from about 0.75 to 1.25 mg KOH. In one embodiment, the polyglycerol polyricinoleic acid has an acid value of from about 0.8 to 0.95 mg KOH.

### ii) Alkaline Value

In one embodiment, the polyglycerol polyricinoleic acid has an alkaline value of about 2.5 to about 4.0 m/100 g. In one embodiment, the polyglycerol polyricinoleic acid has an alkaline value of about 2.6 to about 3.9 m/100 g. In one embodiment, the polyglycerol polyricinoleic acid has an alkaline value of about 2.6 to about 3.5 m/100 g. In one embodiment, the polyglycerol polyricinoleic acid has an alkaline value of about 2.6 to about 3.2 m/100 g. In one embodiment, the polyglycerol polyricinoleic acid has an alkaline value of about 2.7 to about 3.0 m/100 g.

iii) Saponification Value

In one embodiment, the polyglycerol polyricinoleic acid has a saponification value of about 175.0 to about 185.0 mgKOH. In one embodiment, the polyglycerol polyricinoleic acid has a saponification value of about 175.0 to about 184.0 mgKOH. In one embodiment, the polyglycerol polyricinoleic acid has a saponification value of about 175.0 to about 183.0 mgKOH. In one embodiment, the polyglycerol polyricinoleic acid has a saponification value of about 175.0 to about 182.0 mgKOH. In one embodiment, the polyglycerol polyricinoleic acid has a saponification value of about 175.0 to about 181.0 mgKOH. In one embodiment, the polyglycerol polyricinoleic acid has a saponification value of about 175.0 to about 180.0 mgKOH. In one embodiment, the polyglycerol polyricinoleic acid has a saponification value of about 176.0 to about 178.0 mgKOH.

### iv) Hydroxyl Value

In one embodiment, the polyglycerol polyricinoleic acid has an hydroxyl value of about 80.0 to about 100.0 mgKOH. In one embodiment, the polyglycerol polyricinoleic acid has an hydroxyl value of about 85.0 to about 100.0 mgKOH. In one embodiment, the polyglycerol polyricinoleic acid has an hydroxyl value of about 86.0 to about 100.0 mgKOH. In one embodiment, the polyglycerol polyricinoleic acid has an hydroxyl value of about 87.5 to about 100.0 mgKOH. In one embodiment, the polyglycerol polyricinoleic acid has an hydroxyl value of about 89.0 to about 100.0 mgKOH. In one embodiment, the polyglycerol polyricinoleic acid has an hydroxyl value of about 92.0 to about 98.0 mgKOH.

### v) Peroxide Value

In one embodiment, the polyglycerol polyricinoleic acid has a peroxide value of less than or equal to 3.0 me/kg. In one embodiment, the polyglycerol polyricinoleic acid has a peroxide value of less than or equal to 2.5.0 me/kg. In one embodiment, the polyglycerol polyricinoleic acid has a peroxide value of less than or equal to 2.0 me/kg. In one embodiment, the polyglycerol polyricinoleic acid has a peroxide value of less than or equal to 1.0 me/kg. In one embodiment, the polyglycerol polyricinoleic acid has a peroxide value of less than or equal to 0.5 me/kg. In one embodiment, the polyglycerol polyricinoleic acid has a peroxide value of about 0.0 me/kg.

### vi) Iodine Value

In one embodiment, the polyglycerol polyricinoleic acid has an iodine value of about 72 to about 100 gl₂. In one embodiment, the polyglycerol polyricinoleic acid has an iodine value of about 72 to about 95 gl₂. In one embodiment, the polyglycerol polyricinoleic acid has an iodine value of about 72 to about 90 gl₂. In one embodiment, the polyglycerol polyricinoleic acid has an iodine value of about 72 to about 85 gl₂. In one embodiment, the polyglycerol polyricinoleic acid has an iodine value of about 72 to about 84 gl₂.

vii) Refractive Index

In one embodiment, the polyglycerol polyricinoleic acid has a refractive index of about 1,4630 to about 1,4665. In one embodiment, the polyglycerol polyricinoleic acid has a refractive index of about 1,4640 to about 1,4665. In one embodiment, the polyglycerol polyricinoleic acid has a refractive index of about 1,4645 to about 1,4665. In one embodiment, the polyglycerol polyricinoleic acid has a refractive index of about 1,4650 to about 1,4665.

The above mentioned physical characteristics are measured according to the following analytical methods.

| | |
|---|---|
| Acid value (AV) | FAO Food and Nutrition Paper 5, Rev. 2, p. 189 |
| Alkaline value (ALV) | AOCS, Da 4a-48 |
| Saponification value | FAO Food and Nutrition Paper 5, Rev. 2, |
| (SV) | p. 203-204 |
| Hydroxyl value (OHV) | FAO Food and Nutrition Paper 5, Rev. 2, |
| | p. 190-191 |
| Refractive index | FAO Food and Nutrition Paper 5, Rev. 2, p. 45 |
| Iodine value (IV) | FAO Food and Nutrition Paper 5, Rev. 2, p. 194 |
| Peroxide value (PV) | AOCS, Cd 8-53 |

In one embodiment, the polyglycerol polyricinoleic acid has more than one of the above mentioned characteristics i) to vii). In one embodiment, the polyglycerol polyricinoleic acid has all of the above mentioned characteristics i) to vii).

In one embodiment, the polyglycerol polyricinoleic acid has at least one of the above mentioned characteristics i) to vii). In one embodiment, the polyglycerol polyricinoleic acid has more than one of the above mentioned characteristics i) to vii). In one embodiment, the polyglycerol polyricinoleic acid has all of the above mentioned characteristics i) to vii).

The composition employed in the use of the present invention may be prepared at concentrations which are suitable for use in foodstuffs according to recommended daily guidelines.

Alternatively, they may be prepared at higher concentrations and subsequently diluted to a concentration which is suitable for use in foodstuffs according to recommended daily guidelines. Where the composition is prepared at the higher concentration, the composition may comprise at least 10 wt. % polyglycerol polyricinoleic acid. In one embodiment, the composition comprises at least 20 wt. % polyglycerol polyricinoleic acid. In one embodiment, the composition comprises at least 30 wt. % polyglycerol polyricinoleic acid. In one embodiment, the composition comprises at least 40 wt. % polyglycerol polyricinoleic acid. In one embodiment, the composition comprises at least 50 wt. % polyglycerol polyricinoleic acid. In one embodiment, the composition comprises at least 60 wt. % polyglycerol polyricinoleic acid. In one embodiment, the composition comprises at least 70 wt. % polyglycerol polyricinoleic acid. In one embodiment, the composition comprises at least 80 wt. % polyglycerol polyricinoleic acid. In one embodiment, the composition comprises at least 90 wt. % polyglycerol polyricinoleic acid. In one embodiment, the composition consists essentially of polyglycerol polyricinoleic acid.

In this regard, “consisting essentially of” is defined herein as meaning that in addition to the components which are recited, other components may also be present in the composition, provided that the essential characteristics of the composition are not materially affected by their presence.

In one embodiment, the composition employed in the use of the present invention is present in the foodstuff system in an amount such that the amount of PGPR present in the foodstuff is less than the recommended guideline daily amount. In one embodiment, the composition employed in the use of the present invention is present in the foodstuff system in an amount of at least about 0.01% w/w based on the total weight of the foodstuff system. In one embodiment, the composition employed in the use of the present invention is present in the foodstuff system in an amount of at least about 0.015% w/w based on the total weight of the foodstuff system. In one embodiment, the composition employed in the use of the present invention is present in the foodstuff system in an amount of at least about 0.02% w/w based on the total weight of the foodstuff system. In one embodiment, the composition employed in the use of the present invention is present in the foodstuff system in an amount of at least about 0.025% w/w based on the total weight of the foodstuff system. In one embodiment, the composition employed in the use of the present invention is present in the foodstuff system in an amount of at least about 0.03% w/w based on the total weight of the foodstuff system.

In one embodiment, the composition employed in the use of the present invention is present in the foodstuff system in an amount of from about 0.01 to about 0.03% w/w based on the total weight of the foodstuff system. In one embodiment, the composition employed in the use of the present invention is present in the foodstuff system in an amount of from about 0.015 to about 0.025% w/w based on the total weight of the foodstuff system. In one embodiment, the composition employed in the use of the present invention is present in the foodstuff system in an amount of from about 0.018 to about 0.022% w/w based on the total weight of the foodstuff system.

As will be appreciated, the amount of polyglycerol polyricinoleic acid present based on the total weight of the foodstuff system will depend on the amount of polyglycerol polyricinoleic acid present in the composition and the amount of the composition present in the foodstuff system. Thus, where the composition comprises at least 10% w/w polyglycerol polyricinoleic acid, and the composition is present in the foodstuff system in an amount of at least 0.01% by weight based on the total weight of the foodstuff system, the amount of polyglycerol polyricinoleic acid present is at least about 0.001% w/w of the total foodstuff system. Where composition comprises at least 90% w/w polyglycerol polyricinoleic acid, and the composition is present in the foodstuff system in an amount of at least 0.03% by weight based on the total weight of the foodstuff system, the amount of polyglycerol polyricinoleic acid present is at least about 0.027% w/w of the total foodstuff system.

Therefore, in one embodiment, polyglycerol polyricinoleic acid is present in the foodstuff system in an amount of from about 0.001% w/w to about 0.03% w/w based on the total weight of the foodstuff system. In one embodiment, polyglycerol polyricinoleic acid is present in the foodstuff system in an amount of from about 0.002% w/w to about 0.028% w/w based on the total weight of the foodstuff system. In one embodiment, polyglycerol polyricinoleic acid is present in the foodstuff system in an amount of from about 0.005% w/w to about 0.025% w/w based on the total weight of the foodstuff system. In one embodiment, polyglycerol polyricinoleic acid is present in the foodstuff system in an amount of from about 0.01% w/w to about 0.02% w/w based on the total weight of the foodstuff system.

It is envisaged that any combination of the above mentioned amounts of polyglycerol polyricinoleic acid present in the composition and the amount of the composition present in the foodstuff system can be used in the present invention. The skilled person will readily understand that the amount of polyglycerol polyricinoleic acid which should be present in the foodstuff system should be such that heat induced foam generation can be controlled. Thus, the above mentioned concentrations of the compositions and the amount of polyglycerol polyricinoleic acid in the foodstuff system also apply to applications where the foodstuff system is being prepared in bulk.

### The Composition of the Present Invention May be in the Form of a Powder.

### Heating

It will be understood that the present invention is employed where a foodstuff is heated to such a degree that the liberation of gas from the foodstuff system is induced. In one embodiment, the foodstuff system may be heated to the extent that the foodstuff system boils or approaches boiling. In this regard, aqueous liquids typically boil at approximately 100° C. Thus, in one embodiment of the present invention, the foodstuff system is heated to approximately 100° C. However, it will be understood that in some environments, the foodstuff system will begin to boil (liberate steam) at temperatures below 100° C. Thus, in one embodiment of the present invention, the foodstuff system is heated to around or above 50° C. In one embodiment of the present invention, the foodstuff system is heated to above 60° C. In one embodiment of the present invention, the foodstuff system is heated to above 70° C. In one embodiment of the present invention, the foodstuff system is heated to above 80° C. In one embodiment of the present invention, the foodstuff system is heated to above 90° C. Therefore, it may be that the foodstuff system is heated to a temperature which is slightly below 100° C. yet still displays the physical signs of heat induced foam generation. Thus, in one embodiment of the present invention, the foodstuff system is heated to such a degree that heat induced foam generation would typically be expected absent the presence of the composition defined herein.

In one embodiment of the present invention, the foodstuff system is heated from around 50° C. to 110° C. In one embodiment of the present invention, the foodstuff system is heated from around 60° C. to 110° C. In one embodiment of the present invention, the foodstuff system is heated from around 70° C. to 110° C. In one embodiment of the present invention, the foodstuff system is heated from around 80° C. to 110° C. In one embodiment of the present invention, the foodstuff system is heated from around 90° C. to 110° C.

Heating may be performed by any suitable means. The method of heating will often depend on the preference of the consumer and the suitability of the particular foodstuff system to any particular method. Examples of heating methods include convection heating, conduction heating, induction heating and heating by radiation. Typical methods for heating foodstuff systems as defined herein include heating on a stove or gas hob/burner (conduction) or in a microwave (radiation).

In one embodiment, the foodstuff system is heated by microwave radiation. In one embodiment, the foodstuff is heated by microwave radiation to a degree sufficient to induce foam generation from the foodstuff system.

In a second aspect of the present invention, there is provided an anti foaming composition comprising polyglycerol polyricinoleic acid.

According to the present invention, an “anti-foaming” composition is any composition which has the effect of controlling the heat induced foam generation in a foodstuff system when said foodstuff system is heated. In one embodiment, the anti-foaming composition reduces the amount of heat induced foam generation in the foodstuff when heated.

In one embodiment, the foodstuff system is as defined above.

In one embodiment, the composition comprises polyglycerol polyricinoleic acid and is as defined above.

In one embodiment, the polyglycerol polyricinoleic acid has one or more, or all, of the characteristics i) to vii) defined above.

### Broad Aspects

The present invention also encompasses the following aspects:
Use of a composition to control the degree of heat induced foam generation in a system, such as an aqueous system, wherein the composition comprises polyglycerol polyricinoleic acid.
Use of a composition to control the degree of foam generation in a system, such as an aqueous system, wherein the foam is generated, for example, as a result of gas injection, agitation and/or microbiological action, wherein the composition comprises polyglycerol polyricinoleic acid.

Thus, the present invention is not confined to foodstuff systems, but may also be employed in any system which requires the control of foam generation.

The preferable aspects described herein also apply to the broad aspects of the invention as discussed above.

### BRIEF DESCRIPTION OF THE SEVERAL VIEWS OF THE DRAWING

FIG. 1a—Shows two samples (sample 1 and 2) of milk before heating.

FIG. 1b—Shows two samples (sample 1 and 2) of milk after heating.

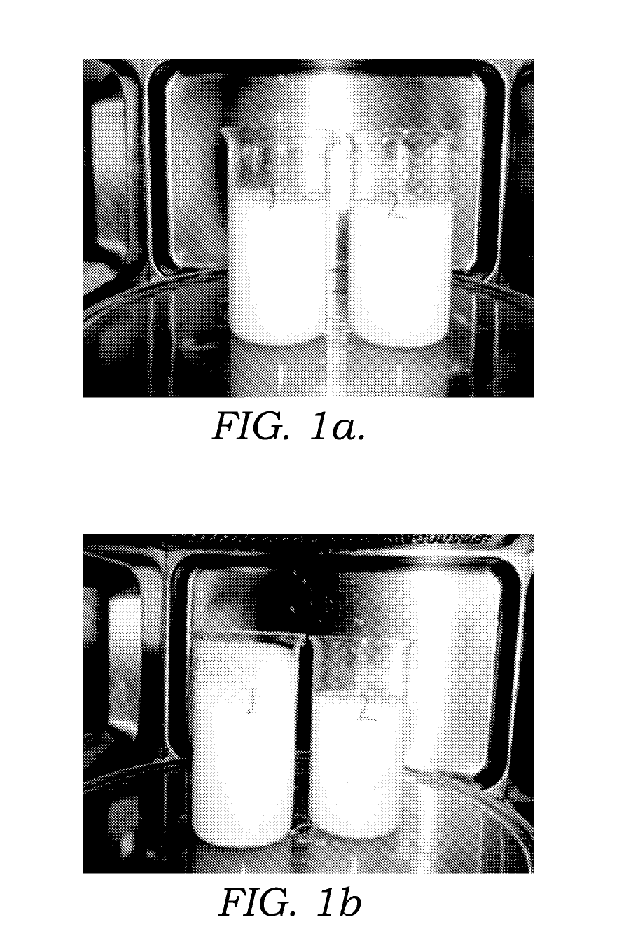

### DETAILED DESCRIPTION OF THE INVENTION

The present invention will now be defined with reference to the following non-limiting examples.

### Example 1

### Production of Fatty Acids (Ricinoleic Acid)

Ricinoleic acid is typically produced from castor oil fatty acids which have been hydrolyzed and distilled.

The typical fatty acid composition of commercially available fatty acids from castor oil are:

TABLE 1
A typical fatty acid composition of castor oil fatty acids.

| Fatty acid composition | % |
|---|---|
| % C16 | 1.0 |
| % C17 | <0.1 |
| % C18 | 1.1 |
| % C 18:1 | 3.1 |
| % C18:2 | 4.2 |
| % C20 | <0.1 |
| % C18:1-OH, ricinoleic acid | 90.4 |
| Total | 99.8 |

The production of ricinoleic acid from castor oil is as follows:

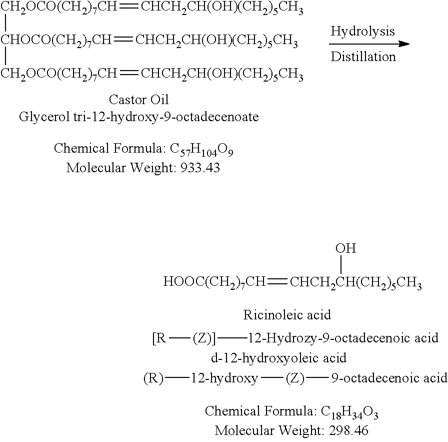

### Example 2

### Production of Polymerized Fatty Acids (Polymerized Ricinoleic Acid)

The fatty acid is heated up to about 200-210° C. and the pressured lowered to about 20-30 mBar to remove reaction water from the esterification. Catalysts like bases can optionally be used but are not necessary for polymerization to take place.

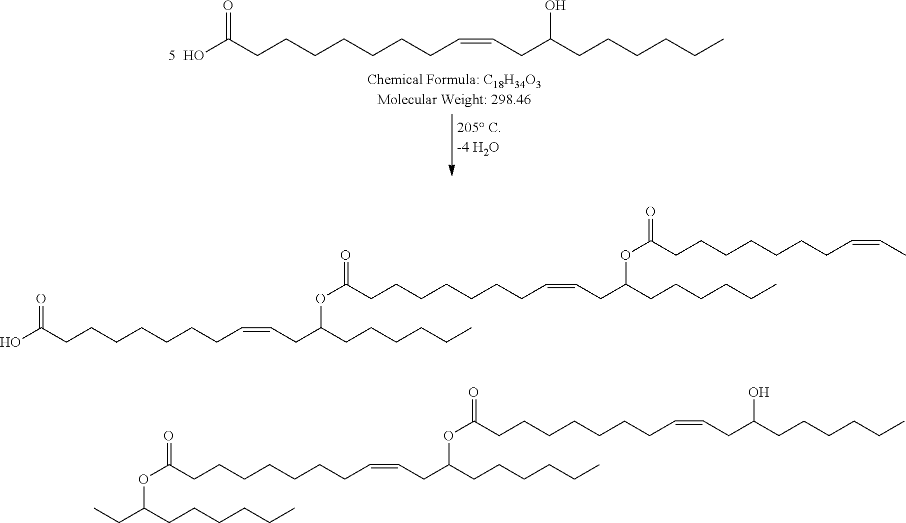

The degree of polymerization is controlled by measuring the acid value (AV) of the mixture (as described in FAO Food and Nutrition Paper 5, Rev. 2, p. 189). Typically, values between AV=30-60 are used.

The resulting polyricinoleic acid is a viscous brownish clear liquid.

### Example 3

### Production of Polyglycerols

Polyglycerols are produced as follows:

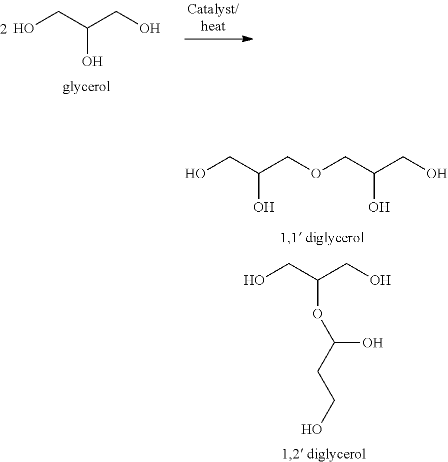 [SMILES: OCC(O)CO ; OCC(O)COCC(O)CO ; OCCC(O)OC(CO)CO]

The number of glycerol units present in the polyglycerol can be varied by terminating the reaction at various stages. In particular, the processes for making polyglycerols can be found, for example, in “Emulsifiers in Food Technology”, Blackwell Publishing, edited by RJ Whithurst, page 110 to 130.

### Example 4

### Production of Polyglycerol Esters of Polymerized Fatty Acids (Polyglycerol Ester of Polymerized Ricinoleic Acid from Triglycerol)

The polyglycerol of example 3 is added to the mixture of polyricinoleic acids of example 2. A catalyst is also added to the mixture, typically a base, e.g. sodium hydroxide, potassium hydroxide, or other suitable bases. The reaction mixture is heated to between 200 and 210° C. and the pressure of the system lowered to eliminate water.

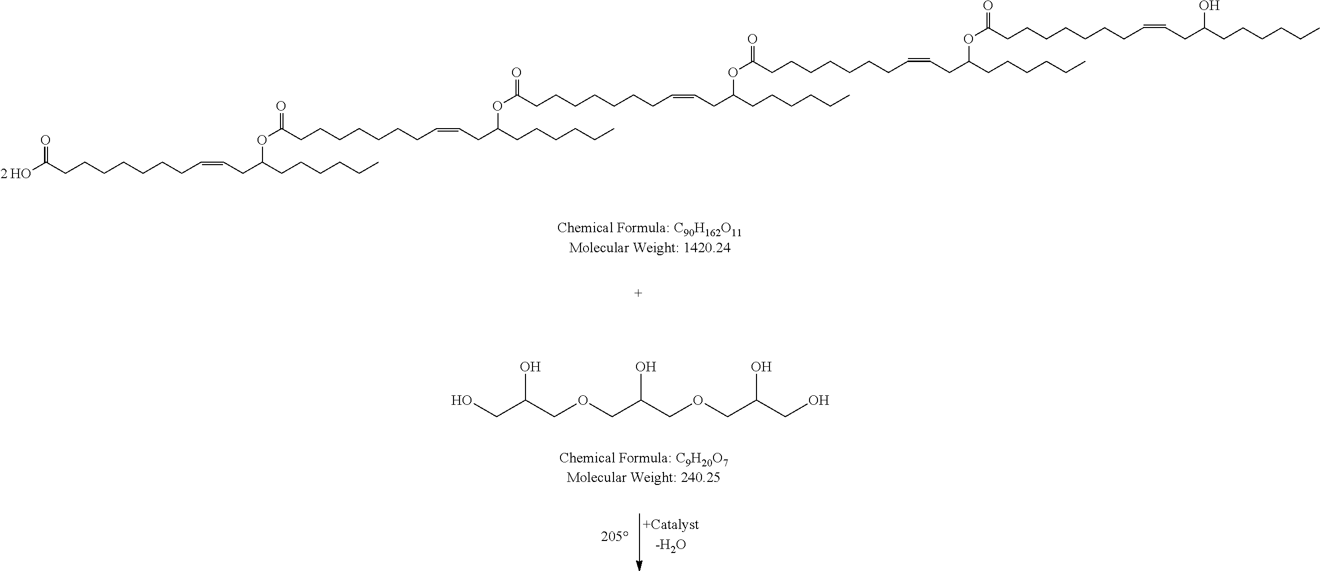 [SMILES: CCCCCCC(O)C/C=C\CCCCCCCC(=O)OC(C/C=C\CCCCCCCC(=O)OC(C/C=C\CCCCCCCC(=O)OC(C/C=C\CCCCCCCC(=O)OC(C/C=C\CCCCCCCC(=O)O)CCCCCC)CCCCCC)CCCCCC)CCCCCC ; OCC(O)COCC(O)COCC(O)CO]

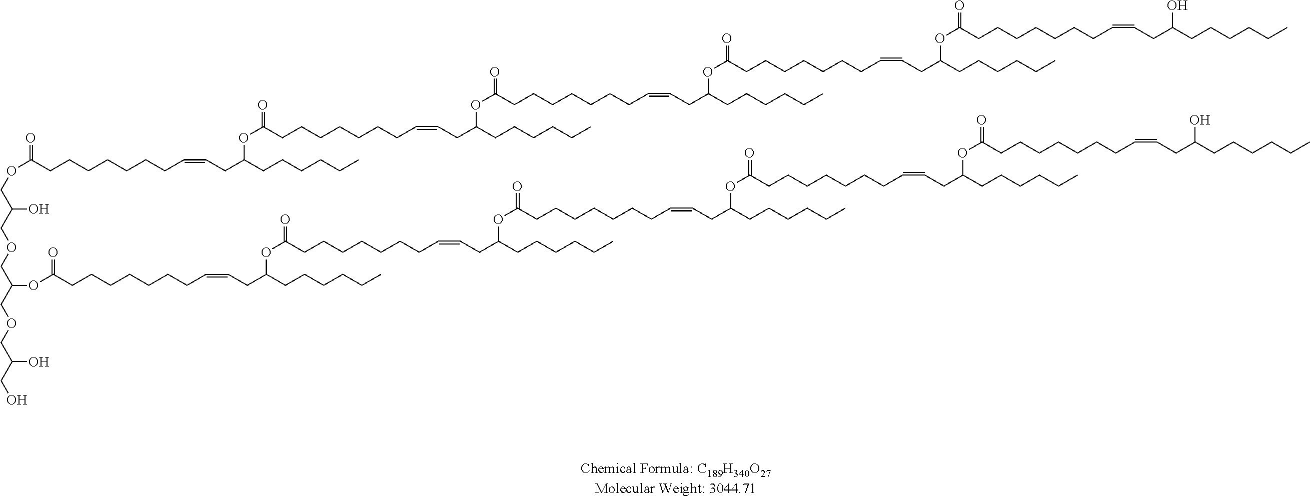 [SMILES: CCCCCCC(O)C/C=C\CCCCCCCC(=O)OC(C/C=C\CCCCCCCC(=O)OC(C/C=C\CCCCCCCC(=O)OC(C/C=C\CCCCCCCC(=O)OC(C/C=C\CCCCCCCC(=O)OCC(O)COCC(COCC(O)CO)OC(=O)CCCCCCC/C=C\CC(CCCCCC)OC(=O)CCCCCCC/C=C\CC(CCCCCC)OC(=O)CCCCCCC/C=C\CC(CCCCCC)OC(=O)CCCCCCC/C=C\CC(CCCCCC)OC(=O)CCCCCCC/C=C\CC(O)CCCCCC)CCCCCC)CCCCCC)CCCCCC)CCCCCC]

The reaction is considered finished when the acid value of the mixture is below 6. The reaction product is then filtered.

The reaction products are then analysed according to the test methods described herein to determine their physical characteristics i) to vii) as described herein.

### Example 5

### Determination of Heat Induced Foam Generation Control Using Pasta and Water

### Procedure:

Weigh Pasta in a 600 ml beaker.

Add water to pasta.

Place the beaker on a hot plate, cover, and turn heat on high.

Wait until product boils to approximately the 300 ml mark on the beaker.

Remove lid and add a drop of the composition used to control boil-over.

Start the timer and record until the foam reaches the 300 ml mark on the beaker again.

Record the time and the volume of foam achieved.

### Formula:

| | |
|---|---|
| Pasta | 10 grams |
| Water | 35 grams |
| Composition | 1 drop (most cases approximately 0.01 gram) |

### Products Evaluated:

| Products of the Invention | Comparison Products |
|---|---|
| PGPR (2500/034) | Citrem LR 10 |
| PGPR (2526/054) | Citrem 2-in-1 |
| PGPR 90 | Panodan S - Visco Lo 2000 |
| | Soybean Oil |
| | Canola Oil |
| | Panodan SD P |
| | Panodan 150 |
| | MCT 60X |
| | Olive Oil |
| | Dimodan SO |
| | Salt |
| | Enova ® Oil |
| | Polysorbate 60 |
| | PGE 0 80 |
| | Acetem 95 |
| | Acetem 90-50 |

### PGPR (Polyglycerol Polyricinoleic Acid)

PGPR (2500/054) was produced according to Example 4 and had the following characteristics:

| Physical characteristic | Value |
|---|---|
| Acid value | 0.9 |
| Alkaline vlaue | 3.0 |
| Saponifcation value | 177.7 |
| Hydroxyl value | 97.7 |
| Peroxide value | 0.0 |
| Iodine value | 83 |
| Refractive Index | 1,4654 |

PGPR (2526/054) was produced according to Example 4 and had the following characteristics:

| Physical characteristic | Value |
|---|---|
| Acid value | 1.0 |
| Alkaline vlaue | 2.7 |
| Saponifcation value | 176.2 |
| Hydroxyl value | 92.6 |
| Peroxide value | 0.0 |
| Iodine value | 74 |
| Refractive Index | 1,4662 |

The above characteristics were measured using the following analytical methods:

TABLE 2
Analytical methods used for measuring physical characteristics of
polyglycerol esters of polymerized fatty acids.

| | |
|---|---|
| Acid value | FAO Food and Nutrition Paper 5, Rev. 2, p. 189 |
| Saponification | FAO Food and Nutrition Paper 5, Rev. 2, p. 203-204 |
| value | |
| Hydroxyl value | FAO Food and Nutrition Paper 5, Rev. 2, p. 190-191 |
| Refractive index | FAO Food and Nutrition Paper 5, Rev. 2, p. 45 |
| Iodine value | FAO Food and Nutrition Paper 5, Rev. 2, p. 194 |
| Peroxide value | AOCS, Cd 8-53 |
| Alkaline value | AOCS, Da 4a-48 |

### Results:

A first round of trials was performed to eliminate the items that showed little or no effect on the control of heat induced foam generation compared to the compositions comprising polyglycerol polyricinoleic acid (PGPR). This eliminated five items (Polysorbate 60, Olive Oil, Soybean Oil, Canola Oil, and Citrem 2-in-1). The remainder of the items were rechecked using the time and volume measurements.

The ability to suppress foam below the 300 ml mark is an indication of a composition which is useful in controlling the degree of heat induced foam generation.

The results are outlined in the table below:

TABLE 3
Heat induced foam generation results using the procedure of Example 5

| | | | Beaker |
|---|---|---|---|
| Product | Comments | Seconds | Level (ml) |
| Acetem 90-50 | Foamed with large unstable | 15.93 | 300 |
| (control) | foam | | |
| Citrem LR 10 | Foamed | 14.22 | 300 |
| Panodan S | Foamed | 13.09 | 300 |
| Visco Lo | | | |
| 2000 | | | |
| Panodan SD P | Foamed | 12.04 | 600 |
| Acetem 95 CO | Slightly better than control, | 23.85 | 250 |
| | large unstable foam | | |
| PGPR 90 | Held foam down very well | 26.07 | 200 |
| MCT 60X | Foamed | 11.93 | 300 |
| Dimodan SO | Foamed | 8.38 | 300 |
| Salt | Foamed | 10.94 | 300 |
| Panodan 150 (not | Foamed | 16.72 | 400 |
| melted) | | | |
| Enova ® Oil | Went to 300 ml briefly with | 16.4 | 300 |
| | very large bubble cells. Then | | |
| | went back to nothing | | |
| PGPR (2500/034) | Foam rose to 150 ml and then | 140 sec | 150 peak |
| | stayed below the 100 ml | (test | and then |
| | mark for the duration | stopped) | 100 ml |
| PGPR (2526/054) | Foam rose to 150 ml and then | 140 sec | 150 peak |
| | stayed below the 100 ml | (test | and then |
| | mark for the duration. | stopped) | 100 ml |
| PGE 0 80 | Foamed | 41.69 | 400 |

The lower the level of foam generated in the beaker, the better the sample is at controlling the degree of heat induced foam generation in the heated foodstuff system.

### CONCLUSION

PGPR 90 resulted in a decrease in foaming and was able to deter foam development for several seconds, even better than the control (Acetem 90-50).

PGPR (2500/034) and PGPR (2526/054) were also good.

Accordingly, it can be seen that compositions comprising polyglycerol polyricinoleic acid are able to control the degree of heat induced foam generation in a foodstuff system when that foodstuff system is heated.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the following claims.

1.-21. (canceled)

22. A composition to control a degree of heat induced foam generation in a foodstuff system when the foodstuff system is heated, wherein the composition comprises a polyglycerol polyricinoleic acid.

23. The composition of claim 1, wherein the polyglycerol polyricinoleic acid comprises one or more of the polyglycerol polyricinoleic acids selected from a group consisting of diglycerol, triglycerol, tetraglycerol, pentaglycerol, hexaglycerol, heptaglycerol, octaglycerol, nonaglycerol or decaglycerol.

24. The composition of claim 1, wherein the polyglycerol polyricinoleic acid comprises at least one of the following characteristics:
i) an acid value of less than or equal to 2.0 mg KOH;
ii) an alkaline value of about 2.5 to about 4.0 m/100 g;
iii) a saponification value of about 175.0 to about 185.0 mgKOH;
iv) an hydroxyl value of about 80.0 to about 100.0 mgKOH;
v) a peroxide value of less than or equal to 3.0 me/kg;
vi) an iodine value of about 72 to about 100 gl₂; and
vii) a refractive index of about 1,4630 to about 1,4665.

25. The composition of claim 3, wherein the polyglycerol polyricinoleic acid comprises more than one of the characteristics i) to vii).

26. The composition of claim 3, wherein the polyglycerol polyricinoleic acid comprises all of the characteristics i) to vii).

27. The composition of claim 1, wherein the composition comprises at least 10% polyglycerol polyricinoleic acid.

28. The composition of claim 1, wherein the composition comprises at least 20% polyglycerol polyricinoleic acid.

29. The composition of claim 1, wherein the composition comprises at least 30% polyglycerol polyricinoleic acid.

30. The composition of claim 1, wherein the composition comprises at least 40% polyglycerol polyricinoleic acid.

31. The composition of claim 1, wherein the composition comprises at least 50% polyglycerol polyricinoleic acid.

32. A composition comprising polyglycerol polyricinoleic acid in a foodstuff system to control a degree of heat induced foam generation in the foodstuff system when the foodstuff system is heated to the degree that heat induced foam generation would occur absent a presence of the composition, wherein the composition is added in an amount from about 0.01 to about 0.03% w/w based on a total weight of the foodstuff system.

33. The composition of claim 11, wherein the foodstuff system is heated to a temperature necessary to allow the foodstuff system to boil or approach boiling.

34. The composition of claim 11, wherein the foodstuff system comprises a foodstuff combined with a liquid.

35. The composition of claim 11, wherein the foodstuff system is heated by one or more of convection heating, conduction heating, induction heating or heating by radiation.

36. The composition of claim 11, wherein the foodstuff system is heated to at least a boiling point of the foodstuff system.

37. The composition of claim 11, wherein the heating is carried out by microwave heating.

38. The composition of claim 11, wherein the composition comprises an anti-foaming property.

39. A method of providing a foodstuff system, the method comprising:
providing a foodstuff;
adding a composition to the foodstuff that controls a degree of heat induced foam generation of the foodstuff, wherein the composition comprises polyglycerol polyricinoleic acid; and
heating the foodstuff system to a degree that heat induced foam generation would occur absent a presence of the composition, wherein the degree of heat induced foam generation is controlled when the composition is added to the foodstuff.

40. The method of claim 18, wherein the foodstuff system is heated by one or more of convection heating, conduction heating, induction heating or heating by radiation.

41. The method of claim 18, wherein a temperature of the foodstuff system is heated to the degree to allow the foodstuff system to boil or approach boiling.
